(19) United States
(12) Patent Application Publication
(10) Pub. No.: US 2009/0128965 A1
(43) Pub. Date: May 21, 2009

(54) CPP MAGNETO-RESISTIVE ELEMENT PROVIDED WITH A PAIR OF MAGNETIC LAYERS AND NICR BUFFER LAYER

(76) Inventors: Tomohito MIZUNO, Tokyo (JP); Yoshihiro TSUCHIYA, Tokyo (JP); Shinji HARA, Tokyo (JP); Koji SHIMAZAWA, Tokyo (JP); Daisuke MIYAUCHI, Tokyo (JP); Takahiko MACHITA, Tokyo (JP); Tsutomu CHOU, Tokyo (JP); Toshiyuki AYUKAWA, Tokyo (JP); Hironobu MATSUZAWA, Tokyo (JP); Tsuyoshi ICHIKI, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/940,511

(22) Filed: Nov. 15, 2007

(51) Int. Cl. G11B 5/33

(52) U.S. Cl. 360/324

(57) ABSTRACT

A magnetic field detecting element has a stack which includes a NiCr layer, a first magnetic layer whose magnetization direction varies in accordance with an external magnetic field, a non-magnetic spacer layer, and a second magnetic layer whose magnetization direction varies in accordance with the external magnetic field, said NiCr layer, said first magnetic layer, said spacer layer and said second magnetic layer being disposed in this order and being arranged in contact with each other, wherein a sense current is adapted to flow in a direction that is perpendicular to a film surface of said stack; and a bias magnetic layer which is disposed on a side of said stack, said side being opposite to an air bearing surface of said stack, wherein said bias magnetic layer is adapted to apply a bias magnetic field to said stack in a direction that is perpendicular to said air bearing surface. Both first and second magnetic layers have bcc crystalline structures, and said non-magnetic spacer layer has a film configuration in which an insulating layer or a semiconductor layer is inserted into a metal layer.

### BACKGROUND OF THE INVENTION

1. Field of the Invention

The present invention relates to a magnetic field detecting element, and in particular, to a magnetic field detecting element having a pair of magnetic layers.

2. Description of the Related Art

Giant Magneto-Resistance (GMR) elements are known as a read element that is used for a thin film magnetic head. Conventionally, CIP (Current In Plane)-GMR elements, in which sense current flows parallel with the film surface of the element, have been mainly used, but recently, elements in which sense current flows in a direction that is perpendicular to the film surface of the element have been developed in order to cope with higher recording density. CPP (Current Perpendicular to the Plane)-GMR elements which utilize the GMR effect are known as the latter type.

A CPP-GMR element typically has a stack that includes a magnetic layer whose magnetization direction varies in accordance with an external magnetic field (free layer), a magnetic layer whose magnetization direction is fixed relative to an external magnetic field (pinned layer) and a non-magnetic intermediate layer (spacer layer) sandwiched between the pinned layer and the free layer. On both sides of the stack with regard to the track width direction, bias magnetic layers for applying a bias magnetic field to the free layer are disposed. The free layer is magnetized into a single magnetic domain by the bias magnetic field that is applied from the bias magnetic layers, and as a result, not only linearity of change in electric resistance relative to change in an external magnetic field is enhanced but also the Barkhausen noise can be effectively limited. The relative angle that the magnetization direction of the free layer and the magnetization direction of the pinned layer form therebetween varies in accordance with an external magnetic field, and thereby causes a change in the electrical resistance of the sense current that flows in the direction that is perpendicular to the film surface of the stack. These properties enable detection of an external magnetic field. The stack is magnetically shielded by shield layers at both ends thereof with regard to the direction of stacking.

Recently, further enhancements in linear recording density have been required. However, enhancements in linear recording density require a reduction in the gap between the upper and lower shield layers (the shield gap). The reduction in the shield gap in turns requires a reduction in the film thickness of the stack. However, there is large restriction that results from the film configuration in the conventional CPP-GMR elements. Specifically, the magnetization direction of the pinned layer has to be firmly fixed without being affected by external magnetic fields, and a so-called synthetic pinned layer is usually used for that purpose. The synthetic pinned layer includes an outer pinned layer, an inner pinned layer and a non-magnetic spacer layer formed of Ru or Rh. The non-magnetic spacer layer is sandwiched between the outer pinned layer and the inner pinned layer. An antiferromagnetic layer is provided in contact with the outer pinned layer in order to fix the magnetization direction of the outer pinned layer. The antiferromagnetic layer is typically formed of IrMn. In the synthetic pinned layer, the magnetization direction of the outer pinned layer is fixed due to exchange coupling between the antiferromagnetic layer and the outer pinned layer. The magnetization direction of the inner pinned layer is fixed due to antiferromagnetic coupling that occurs between the inner pinned layer and the outer pinned layer via the non-magnetic spacer layer. Since the inner pinned layer and the outer pinned layer are magnetized in an anti-parallel direction to each other, the magnetization of the pinned layer is limited as a whole. Despite these advantages of the synthetic pinned layer, however, a CPP-GMR element having a synthetic pinned layer requires many layers, and this leads to limiting the degree to which the film thickness of the stack can be reduced.

Recently, novel film configurations which are completely different from conventional stacks have been proposed. U.S. Pat. No. 7,019,371 discloses a CIP element having two free layers whose magnetization directions vary in accordance with an external magnetic field and a non-magnetic spacer layer sandwiched therebetween. U.S. Pat. No. 7,035,062 discloses a CPP-GMR element having two free layers whose magnetization directions vary in accordance with an external magnetic field and a non-magnetic spacer layer sandwiched therebetween. In these elements, the two free layers are exchange-coupled with each other due to the RKKY (Rudermann, Kittel, Kasuya, Yoshida) interaction that occurs via the non-magnetic spacer layer. A bias magnetic layer is disposed on the back side of the stack, as viewed from the air bearing surface, and applies a bias magnetic field in the direction that is perpendicular to the air bearing surface. The magnetization directions of the two free layers form a certain relative angle due to the magnetic field that is applied from the bias magnetic layer. When an external magnetic field is applied from a recording medium in this state, the magnetization directions of the two free layers are changed, and as a result, the relative angle formed by the two free layers is also changed, and thereby, the electrical resistance of the sense current is changed. These properties enable detection of external magnetization. In this way, the film configuration using two free layers, which does not require a conventional synthetic pinned layer and an antiferromagnetic layer, has a simple film configuration which may create the potential for reducing the shield gap.

In such elements that use two free layers, the non-magnetic spacer layer is required not only to cause a magneto-resistive effect but also to couple the two free layers in an anti-parallel direction based on the RKKY interaction. Materials that meet these requirements and that can be preferably used include a metal, such as Cu.

In a CPP-GMR element, in which the sense current flows in a direction that is perpendicular to the stack (spin valve film), the stack is usually formed of metal materials, and as a result, has a significantly low electrical resistance. Low electrical resistance leads to a small change in electrical resistance, and therefore, a large MR ratio can not be obtained. A semiconductor material, such as ZnO, or an insulating material, such as AlO or MgO may be used for the non-magnetic spacer layer for the purpose of increasing the electrical resistance. However, these materials are usually not provided with properties to produce the RKKY interaction. For example, according to a report, it is known that a non-magnetic spacer layer that is made of MgO and that has a film thickness of 0.6 nm exhibits weak RKKY interaction (exchange coupling constant; 0.26×10⁻⁷ J/cm²), but this exchange coupling constant is not enough to generate sufficient exchange coupling between the two free layers, and therefore, a magneto resistance ratio at a practical level can not be obtained. Accordingly, it is difficult for a CPP-GMR element using two free layers to obtain both an increase in the electrical resistance and sufficient exchange coupling between the two free layers, and thereby to achieve a large magneto resistance ratio.

### SUMMARY OF THE INVENTION

The present invention concerns a CPP magnetic field detecting element having a film configuration in which a stack is provided which includes a pair of magnetic layers whose magnetization directions vary in accordance with the external magnetization, similarly to a conventional free layer, and in which a bias magnetic layer is disposed on the back side of the stack as viewed from the air bearing surface. An object of the invention is to provide a magnetic field detecting element that has the above-mentioned film configuration and that is capable of obtaining both an increase in the electrical resistance and sufficient exchange coupling between the two magnetic layers and that is thereby capable of achieving a large magneto resistive effect while enabling a reduction in the shields gap.

According to an embodiment of the present invention, a magnetic field detecting element of the present invention has a stack which includes a NiCr layer, a first magnetic layer whose magnetization direction varies in accordance with an external magnetic field, a non-magnetic spacer layer, and a second magnetic layer whose magnetization direction varies in accordance with the external magnetic field, said NiCr layer, said first magnetic layer, said spacer layer and said second magnetic layer being disposed in this order and being arranged in contact with each other, wherein a sense current is adapted to flow in a direction that is perpendicular to a film surface of said stack; and a bias magnetic layer which is disposed on a side of said stack, said side being opposite to an air bearing surface of said stack, wherein said bias magnetic layer is adapted to apply a bias magnetic field to said stack in a direction that is perpendicular to said air bearing surface. Both first and second magnetic layers have bcc crystalline structures, and said non-magnetic spacer layer has a film configuration in which an insulating layer or a semiconductor layer is inserted into a metal layer.

The inventors of the present application found that by utilizing first and second magnetic layers each having a bcc (body centered cubic) crystalline structure and by disposing a NiCr layer in contact with the first magnetic layer, sufficient exchange coupling can be achieved between the pair of magnetic layers even when a non-magnetic spacer layer that includes an insulating layer or a semiconductor layer, which conventionally can not produce sufficient exchange coupling, is used. This enables both a large magneto resistance ratio and exchange coupling between the pair of magnetic layers, and thereby enables an increase in the electrical resistance. Also, this structure requires neither an antiferromagnetic layer nor a synthetic pinned layer in the stack, and facilitates a reduction in the film thickness of the stack. In this way, it is possible to provide a magnetic field detecting element that has the above-mentioned film configuration and that is capable of achieving a large magneto resistive effect while enabling a reduction in the shields gap.

The above and other objects, features and advantages of the present invention will become apparent from the following description with reference to the accompanying drawings which illustrate examples of the present invention.

### BRIEF DESCRIPTION OF THE DRAWINGS

FIG. 1 shows a conceptual perspective view of a magnetic field detecting element according to a preferred embodiment of the present invention;

FIG. 2A shows a sectional view of the magnetic field detecting element as seen from direction 2A-2A of FIG. 1;

FIG. 2B shows a sectional view of the magnetic field detecting element cut along line 2B-2B of FIG. 1;

FIG. 3 is a conceptual diagram illustrating an operation principle of the magnetic field detecting element shown in FIG. 1;

FIGS. 4A and 4B are graphs showing the magneto resistance ratio in a case in which a NiCr layer is used as a buffer layer and in a case in which a NiCr layer is not used as a buffer layer, respectively;

FIGS. 5A to 5C are graphs showing the relationship between the atomic percent of Cr in the NiCr layer and the exchange coupling constant in a case in which Cu/ZnO/Cu is used as the non-magnetic spacer layer, in a case in which Cu/AZO/Cu is used as the non-magnetic spacer layer and in a case in which Cu/GaN/Cu is used as the non-magnetic spacer layer, respectively.

FIG. 6 is a plan view of a wafer which is used to manufacture the magnetic field detecting element of the present invention;

FIG. 7 is a perspective view of a slider of the present invention;

FIG. 8 is a perspective view of a head arm assembly which includes a head gimbal assembly which incorporates a slider of the present invention;

FIG. 9 is a side view of a head arm assembly which incorporates sliders of the present invention; and

FIG. 10 is a plan view of a hard disk drive which incorporates sliders of the present invention.

### DETAILED DESCRIPTION OF THE PREFERRED EMBODIMENTS

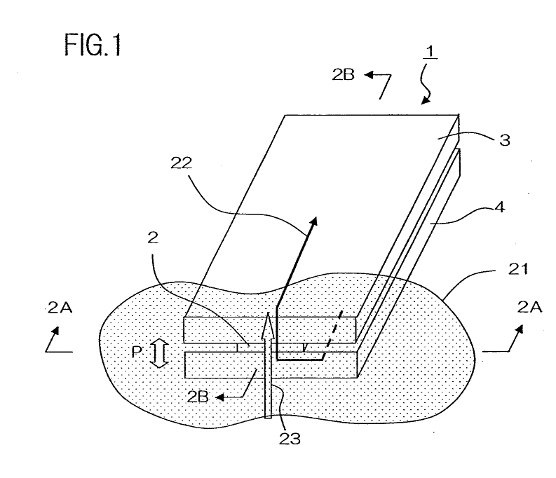

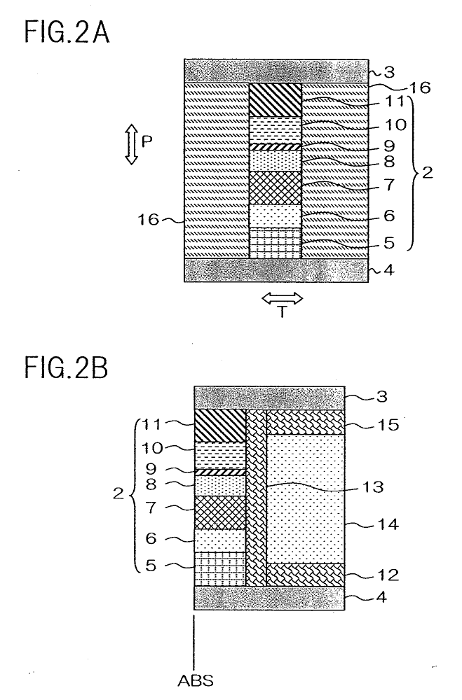

A preferred embodiment of the present invention will be described below with reference to the accompanying drawings. The magnetic field detecting element of the present embodiment is suitable for use as the read head portion of a thin film magnetic head of a hard disk device. FIG. 1 illustrates a conceptual perspective view of the magnetic field detecting element of the present embodiment. FIG. 2A illustrates a side view of the magnetic field detecting element as seen from direction 2A-2A of FIG. 1, i.e. as seen from the air bearing surface; and FIG. 2B illustrates a sectional view of the magnetic field detecting element cut along line 2B-2B of FIG. 1. The air bearing surface refers to the face of magnetic field detecting element 1 that faces recording medium 21.

Magnetic field detecting element 1 includes stack 2, upper shield electrode layer 3 and lower shield electrode layer 4 that sandwich stack 2 in the direction of stacking thereof, bias magnetic layer 14 that is arranged on the backside of stack 2 that is opposite to air bearing surface ABS, and insulating films 16 that are formed of Al₂O₃ or the like and that are disposed on both sides of stack 2 with regard to track width direction T.

Stack 2 is sandwiched between upper shield electrode layer 3 and lower shield electrode layer 4 with the front end thereof being exposed on air bearing surface ABS. Stack 2 is configured to allow sense current 22 to flow in direction P that is perpendicular to the film surface under a voltage that is applied between upper shield electrode layer 3 and lower shield electrode layer 4. The magnetic field of recording medium 21 at the position facing stack 2 changes in accordance with the movement of recording medium 21 in moving direction 23. The change in magnetic field is detected as a change in electric resistance which is caused by the magneto-resistance effect. Based on this principle, magnetic field detecting element 1 reads magnetic information that is recorded in each magnetic domain of recording medium 21.

An exemplary layer configuration of stack 2 is shown in Table 1. In the table, the layers are shown in the order of stacking, from buffer layer 5 in the bottom row, which is on the side of lower shield electrode layer 4, toward cap layer 9 in the top row, which is on the side of upper shield electrode layer 3. In Table 1, the numerals in the column of “Composition” indicate the atomic percent of the elements. Stack 2 has the layer configuration having buffer layer 5, first magnetic layer 6, conductive non-magnetic spacer layer 7, second magnetic layer 8, and cap layer 9, which are stacked in this order on lower shield electrode layer 4 that is made of an 80Ni20Fe layer having a thickness of about 2 μm.

TABLE 1

| Layer Cinfiguration | Composition | Thickness(nm) |
|---|---|---|
| Cap Layer 9 | Ta | 2 |
| | Cu | 1.5 |
| Second Magnetic Layer 8 | 90Co10Fe | 1 |
| | 82Ni18Fe | 2.5 |
| | 90Co10Fe | 1 |
| Non-magnetic Spacer Layer 7 | Cu | 0.8 |
| | ZnO | 1.4 |
| | Cu | 0.8 |
| First Magnetic Layer 6 | 90Co10Fe | 1 |
| | 82Ni18Fe | 2.5 |
| | 90Co10Fe | 1 |
| Buffer Layer 5 | 60Ni40Cr | 5 |
| | Ta | 1 |

Buffer layer 5 is provided as a seed layer for first magnetic layer 6. Buffer layer 5 consists of a single layer made of NiCr or of a Ta/NiCr layer. In other words, buffer layer 5 may be formed at least partly of a NiCr layer. However, it is desirable that the NiCr layer be disposed directly in contact with first magnetic layer 6. In this specification, the notation of A/B/C . . . indicates that the layers A, B and C are stacked in this order. The numeral on the left side of an atomic symbol indicates the atomic percent (unit at. %) of the element. The NiCr layer preferably has a film thickness of 1 to 6 nm. When a Ta layer is provided, the Ta layer preferably has a film thickness of 2 nm or less. The atomic percent of Cr (or Ni) in the NiCr layer will be later described in detail since it highly affects the exchange coupling strength between first magnetic layer 6 and second magnetic layer 8, together with the composition of non-magnetic spacer layer 7.

Both first magnetic layer 6 and second magnetic layer 8 are magnetic layers that are formed of a CoFe/NiFe/CoFe layer whose magnetization direction varies in accordance with an external magnetic field. Magnetic layers 6, 8 preferably have a film thickness of 1 to 5 nm. Magnetic layers 6, 8 may also be formed of CoFe layers having a film thickness of 1 to 5 nm, and in this case, a Cu layer (film thickness: 0.2 to 1 nm) may be inserted into the CoFe layer at any desired elevation of the CoFe layer with regard to the film thickness. This configuration provides a high spin polarization rate at the interface between the CoFe layer and the Cu layer, and thereby enhances the magneto-resistive effect. Two or more Cu layers may also be inserted. Both first magnetic layer 6 and second magnetic layer 8 have bcc (body centered cubic) crystalline structures.

Non-magnetic spacer layer 7 has a film configuration in which a semiconductor layer or an insulating layer is inserted into a non-magnetic metal layer which exhibits magneto-resistive effect. Examples of the non-magnetic metal include Cu, Zn, Ag and Au. Examples of a semiconductor include ZnO, ZnN, SiO, SiN, SiON, SiC, SnO, In₂O₃ and ITO (Indium-Tin-Oxide). Examples of an insulator include AlO, MgO, HfO, RuO and Cu₂O. In particular, the film configuration of Cu/ZnO/Cu is desirable. The structure in which Cu layers are arranged on both sides of the ZnO layer provides an increase in the spin polarization rate at the interface between the CoFe layer and the Cu layer, and thereby enhances the magneto-resistive effect. In the film configuration of Cu/ZnO/Cu, the desirable film thickness of the Cu layer is typically 0.8 nm, and may range between 0.2 to 1.0 nm. The desirable film thickness of the ZnO layer is typically 1.4 nm, and may range between 0.5 to 2.0 nm. Also, a film configuration in which a semiconductor layer is inserted into a Cu layer, such as Cu/AZO/Cu or Cu/GaN/Cu, is desirable. AZO refers to a material that is made of ZnO and that includes Al as an additive. Non-magnetic spacer layer 7 may also be formed of a single layer that is made of the non-magnetic metal, the semiconductor or the insulator mentioned above.

Cap layer 9, which is made of a Cu/Ta layer, is provided to prevent deterioration of the layers formed beneath. On cap layer 9, upper shield electrode layer 3, which is made of a 80Ni20Fe layer having a thickness of about 2 μm, is formed.

Upper shield electrode layer 3 and lower shield electrode layer 4 function as electrodes for supplying sense current to stack 2 in stacking direction P, and also function as shield layers for preventing a magnetic field from being emitted from adjacent bits on the same track of recording medium 21.

As shown in FIG. 2B, bias magnetic layer 14 is formed on the back side of stack 2, as viewed from the air bearing surface, via insulating layers 12, 13, 15. Bias magnetic layer 14 is formed of materials, such as CoPt, CoCrPt. Insulating layers 12, 13, 15 are formed of Al₂O₃ or the like. Bias magnetic layer 14 applies a bias magnetic field to stack 2 in a direction that is perpendicular to air bearing surface ABS, and restrains the magnetization directions of first magnetic layer 6 and third magnetic layer 10. Insulating layers 12, 13, 15 are disposed under bias magnetic layer 14, by the side of bias magnetic layer 14 (between bias magnetic layer 14 and stack 2) and above bias magnetic layer 14, respectively, and prevent sense current 22 from flowing into bias magnetic layer 14.

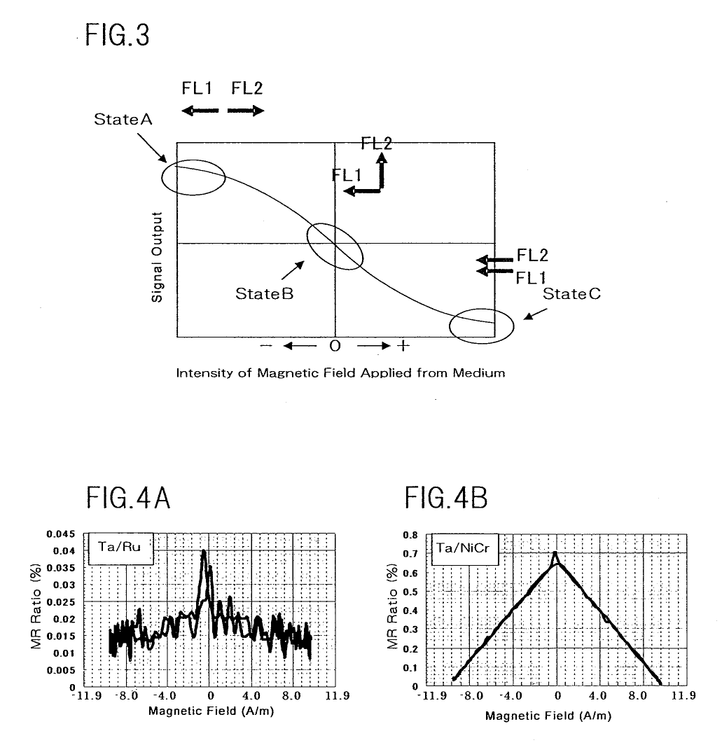

FIG. 3 is a conceptual view showing the operation principle of the magnetic field detecting element of the present embodiment. The abscissa indicates the magnitude of the external magnetic field, and the ordinate indicates the signal output. In the figure, the magnetization direction of second magnetic layer 8 and the magnetization direction of first magnetic layer 6 are indicated by FL1 and FL2, respectively. When neither a bias magnetic field emitted from bias magnetic layer 14 nor an external magnetic field emitted from recording medium 21 exist, the magnetization direction of second magnetic layer 8 and the magnetization direction of first magnetic layer 6 are anti-parallel to each other due to the above-described exchange coupling (A in the figure). However, since a bias magnetic field is actually applied, the magnetization direction of second magnetic layer 8 and the magnetization direction of first magnetic layer 6 are rotated from the anti-parallel state toward a parallel state and reach an intermediate state, which is between the anti-parallel state and the parallel state, at an initial magnetization state (the state in which only a bias magnetic field is applied) (B in the figure). When an external magnetic field is applied from recording medium 21 in this state, the relative angle between the magnetization direction of second magnetic layer 8 and the magnetization direction of first magnetic layer 6 increases (moves to a state that is closer to the anti-parallel state) or decreases (moves to a state that is closer to the parallel state) in accordance with the direction of the magnetic field. If the state comes close to the anti-parallel state, then electrons emitted from the electrode are apt to be scattered, leading to an increase in the electric resistance of the sense current. If the state comes close to the parallel state, then electrons emitted from electrode are less apt to be scattered, leading to a decrease in the electric resistance of the sense current. In this way, by utilizing the change in the relative angle between the magnetization direction of second magnetic layer 8 and the magnetization direction of first magnetic layer 6, an external magnetic field can be detected.

In the present embodiment, as a result of adjusting the thickness and the configuration, etc. of bias magnetic layer 14, the magnetization direction of second magnetic layer 8 and the magnetization direction of first magnetic layer 6 are approximately perpendicular to each other in the initial magnetization state (B in FIG. 3). When the magnetization directions are perpendicular to each other in the initial magnetization state, a large change in output against a change in an external magnetic field, and thus, a large change in magnetic resistance can be obtained, and good asymmetry can also be obtained. Therefore, the initial magnetization state in which the magnetization directions are perpendicular to each other is the ideal initial magnetization state. If the bias magnetic field is insufficient, then the initial magnetization state becomes close to the anti-parallel state (A in FIG. 3), leading to low output and large asymmetry. Similarly, if the bias magnetic field is excessive, then the initial magnetization state becomes close to the parallel state (C in FIG. 3), leading to low output and large asymmetry.

Next, the characteristic features of the present embodiment will be further described in detail. FIG. 4A is a graph showing the magneto resistance ratio when a Ta/Ru layer is used as the buffer layer, i.e., when a NiCr layer is not used as the buffer layer. The film configuration of stack 2 is Ta(1 nm)/Ru(2 nm)/90Co10Fe(1 nm)/82Ni18Fe(2.5 nm)/90Co10Fe(1 nm)/Cu(1.1 nm)/90Co10Fe(1 nm)/82Ni18Fe(2.5 nm)/90Co10Fe(1 nm)/Cu(1.5 nm)/Ta(2 nm). FIG. 4B is a graph showing the magneto resistance ratio when a Ta/60Ni40Cr layer is used as the buffer layer. The film configuration of stack 2 is Ta(1 nm)/60Ni40Cr(5 nm) 190Co10Fe(1 nm)/82Ni18Fe(2.5 nm)/90Co10Fe(1 nm)/Cu(1.1 nm) 90Co10Fe(1 nm)/82Ni18Fe(2.5 nm)/90Co10Fe(1 nm)/Cu(1.5 nm)/Ta(2 nm). Non-magnetic spacer layer 7 consists of a single layer made of Cu. As described above, first magnetic layer 6 and second magnetic layer 8 require being exchange coupled with each other via non-magnetic spacer layer 7, and exchange coupling strength J is significantly influenced by the composition of buffer layer 5. Referring to FIG. 4A, the magneto resistance ratio is extremely low and substantially constant except for the extremely small magnetic fields. This is because no anti-parallel coupling occurs between first magnetic layer 6 and second magnetic layer 8, and therefore, both magnetic layers are magnetically saturated in the direction of the magnetic field even when the external magnetic field is extremely small. On the other hand, when a Ta/60Ni40Cr layer is used as the buffer layer, the magneto resistance ratio is greater than the magneto resistance ratio in the case of FIG. 4A by one order, as shown in FIG. 4B, and furthermore, the magnetic field linearly decreases from the state in which there is no magnetic field. This implies that the region with the linear characteristics can be utilized as a magnetic sensor. In this way, a NiCr alloy can be preferably used as buffer layer 5 so that exchange coupling be generated between first magnetic layer 6 and second magnetic layer 8 via non-magnetic spacer layer 7 made of Cu.

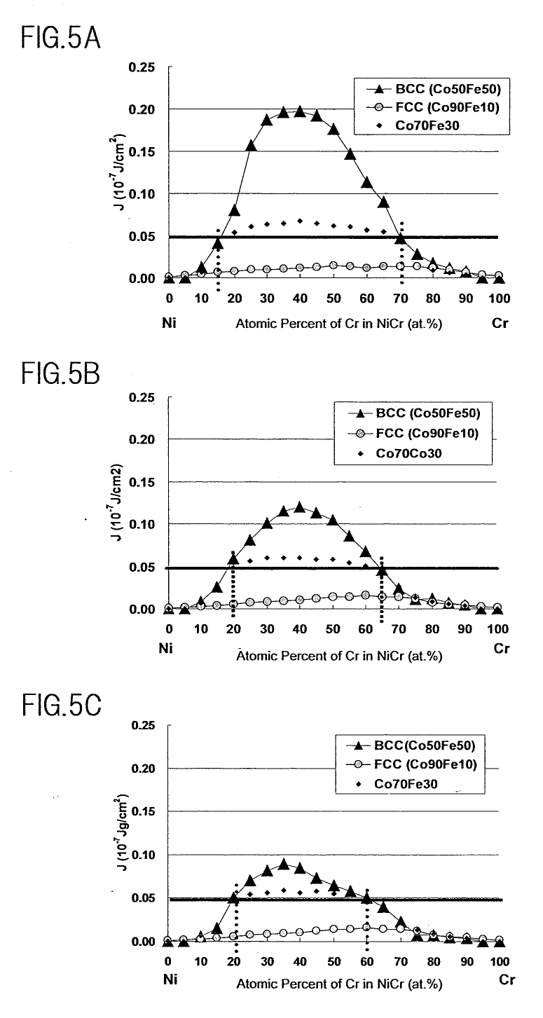

Also, by changing the composition of the NiCr layer that constitutes buffer layer 5, exchange coupling strength J can be increased. This can allow even non-magnetic spacer layer 7 that has a Cu layer and a semiconductor layer or an insulating layer inserted therein to generate anti-parallel coupling. Conventionally, no anti-parallel coupling is generated by a non-magnetic spacer layer having a Cu layer and, for example, ZnO, AZO or GaN inserted therein. However, it is possible to generate anti-parallel coupling by appropriately choosing the composition of the NiCr layer. FIGS. 5A to 5C are graphs showing the relationship between the atomic percent of Cr in the NiCr layer and the exchange coupling constant in a case in which Cu/ZnO/Cu is used as the non-magnetic spacer layer, in a case in which Cu/AZO/Cu is used as the non-magnetic spacer layer and in a case in which Cu/GaN/Cu is used as the non-magnetic spacer layer, respectively. The film configuration of stack 2 is Ta(1 nm)/60Ni40Cr(5 nm)/90Co10Fe(1 nm)/82Ni18Fe(2.5 nm)/90Co10Fe(1 nm)/non-magnetic spacer layer/90Co10Fe(1 nm)/82Ni18Fe(2.5 nm)/90Co10Fe(1 nm)/Cu(1.5 nm)/Ta(2 nm). In order to obtain a magneto resistance ratio of a practical level, exchange coupling constant J of 0.05×10⁻⁷ J/cm² or more is considered to be necessary. This is because the ideal initial state mentioned above is obtained by applying a bias magnetic field of about 1600 A/m (about 20 Oe) when exchange coupling constant J equals to 0.05×10⁻⁷ J/cm², and because an exchange coupling constant that is smaller than this value is insufficient for first and second magnetic layers 6, 8 to react to the bias magnetic field because of the fact that this bias magnetic field intensity is substantially equal to the coercive force of first and second magnetic layers 6, 8. The atomic percent of Cr that meets this condition is 30% or more and 80% or less for a Cu/ZnO/Cu layer, 35% or more and 80% or less for a Cu/AZO/Cu layer, and 40% or more and 90% or less for a Cu/Ga/Cu layer. It was confirmed that the result hardly depends on the film thickness of the NiCr layer.

The fact that exchange coupling constant J largely varies according to the composition of the NiCr layer is thought to result from the fact that the crystalline structure of the CoFe layer changes depending on the composition of the NiCr layer. Specifically, semiconductor materials, such as ZnO, AZO and GaN, have greater lattice constants than CoFe because of oxidization or nitridation, and therefore, do not contribute to exchange coupling when they are used as non-magnetic spacer layer 7. However, by properly choosing the atomic percent of Cr in the NiCr layer within a specific range, an increase in the lattice constant of buffer layer 5 is obtained, which exerts influence on first and second magnetic layers 6, 8 to increase the lattice constants thereof. As a result, mismatching of the lattice constant between semiconductor material, such as ZnO, AZO or GaN, and CoFe in first and second magnetic layers 6, 8 is reduced. The reduction of mismatching of the lattice constant leads to an increase in exchange coupling constant J, enabling even a semiconductor material to generate exchange coupling, which conventionally does not occur, when it is used as non-magnetic spacer layer 7. The same applies to cases in which semiconductor materials or insulator materials other than ZnO, AZO and GaN are used as non-magnetic spacer layer 7. Also when a single layer of Cu is used as non-magnetic spacer layer 7, the mismatching in the lattice constant is further reduced, and exchange coupling constant J is increased.

As will be seen from FIGS. 5A to 5C, an exchange coupling constant of 0.05×10⁻⁷ J/cm² or more can be obtained when first and second magnetic layers 6, 8 have a bcc crystalline structure. When CoFe layers are used as first and second magnetic layers 6, 8, a bcc crystalline structure can be obtained when the atomic percent of Co is 0% or more and 70% or less. If the atomic percent of Co exceeds 70%, then a fcc (face centered cubic) crystalline structure is formed, and no sufficient exchange coupling can be obtained. FIGS. 5A to 5C also show a case in which the atomic percent of Co is 70%, and the exchange coupling constant is substantially equal to 0.05×10⁻⁷ J/cm².

The inventors of the present application think the reason why a large exchange coupling constant can be obtained by using CoFe layers having a bcc crystalline structure as first and second magnetic layers 6, 8 is as follows. First and second magnetic layers 6, 8 have lattice constants that are largely different from that of the semiconductor layer (a wurtzite structure), regardless of whether first and second magnetic layers 6, 8 have a bcc crystalline structure or a fcc crystalline structure. For instance, ZnO has a lattice constant of 0.358 nm, and CoFe having a bcc crystalline structure has a lattice constant of 0.28 nm. Thus, these layers are intrinsically unsuitable for stacking one over the other. However, by inserting a non-magnetic layer, such as Cu, into a semiconductor layer, a satisfactory stack can be obtained without causing the electric characteristics of the semiconductor layer (the resistance and the magneto resistance ratio) to deteriorate. This is because the non-magnetic layer serves as a buffer layer which connects the magnetic layer and the semiconductor layer having lattice constants that are largely different from each other. A bcc crystalline structure has an aspect ratio that is different from that of a fcc crystalline structure on the most closed packed surface thereof, and is considered to be more apt to undergo lattice transformation than a fcc crystalline structure. The lattice transformation helps the non-magnetic layer to work as a buffer layer, and makes it possible for a semiconductor to be formed over the CoFe layer with good film quality. As a result, satisfactory exchange coupling, and thereby an increase in exchange coupling strength J, can be obtained.

The magnetic field detecting element of the present embodiment of the invention can be manufactured by the following process. Lower shield electrode layer 4 is first formed on a substrate, and layers to constitute stack 2 are then formed on lower shield electrode layer 4 by means of sputtering. Next, these layers are formed into a predetermined shape by means of patterning, and insulating films 16 are filled on both sides thereof with regard to track width direction T. Consequently, the layers formed are removed by means of milling except for the portion which defines air bearing surface ABS and has a width that corresponds to the height of the element. Bias magnetic layer 14 is then formed. In this way, insulating films 16 are formed on both sides of stack 2 with regard to track width direction T, and bias magnetic layer 14 is formed on the back side of stack 2, as viewed from air bearing surface ABS. Consequently, upper shield electrode layer 3 is formed.

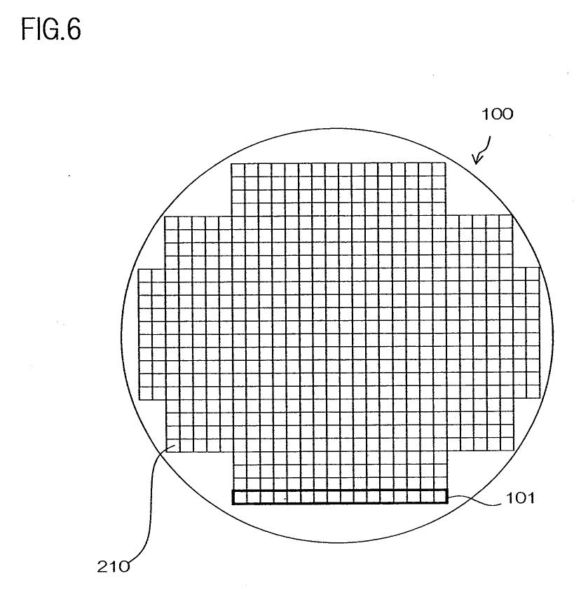

Next, explanation will be made regarding a wafer for fabricating a magnetic field detecting element described above. FIG. 6 is a schematic plan view of a wafer. Wafer 100 has a stack deposited thereon that constitutes at least the magnetic field detecting element described above. Wafer 100 is diced into bars 101 which serve as working units in the process of forming air bearing surface ABS. After lapping, bar 101 is diced into sliders 210 which include thin-film magnetic heads. Dicing portions, not shown, are provided in wafer 100 in order to dice wafer 100 into bars 101 and into sliders 210.

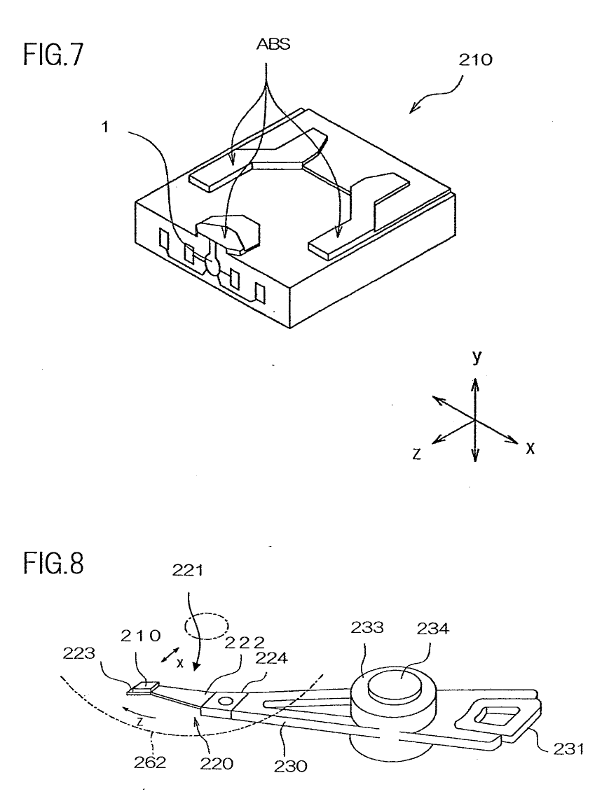

Referring to FIG. 7, slider 210 has a substantially hexahedral shape. One surface out of six the surfaces of slider 210 forms air bearing surface ABS, which is positioned opposite to the hard disk.

Referring to FIG. 8, head gimbal assembly 220 has slider 210 and suspension 221 for resiliently supporting slider 210. Suspension 221 has load beam 222 in the shape of a flat spring and made of, for example, stainless steel, flexure 223 that is attached to one end of load beam 222, and base plate 224 provided on the other end of load beam 222. Slider 210 is fixed to flexure 223 to provide slider 210 with an appropriate degree of freedom. The portion of flexure 223 to which slider 210 is attached has a gimbal section for maintaining slider 210 in a fixed orientation.

Slider 210 is arranged opposite to a hard disk, which is a rotationally-driven disc-shaped storage medium, in a hard disk drive. When the hard disk rotates in the z direction shown in FIG. 8, airflow which passes between the hard disk and slider 210 creates a dynamic lift, which is applied to slider 210 downward in they direction. Slider 210 is configured to lift up from the surface of the hard disk due to this dynamic lift effect. Magnetic field detecting element 1 is formed in proximity to the trailing edge (the end portion at the lower left in FIG. 7) of slider 210, which is on the outlet side of the airflow.

The arrangement in which a head gimbal assembly 220 is attached to arm 230 is called a head arm assembly 221. Arm 230 moves slider 210 in transverse direction x with regard to the track of hard disk 262. One end of arm 230 is attached to base plate 224. Coil 231, which constitutes a part of a voice coil motor, is attached to the other end of arm 230. Bearing section 233 is provided in the intermediate portion of arm 230. Arm 230 is rotatably held by shaft 234 which is attached to bearing section 233. Arm 230 and the voice coil motor to drive arm 230 constitute an actuator.

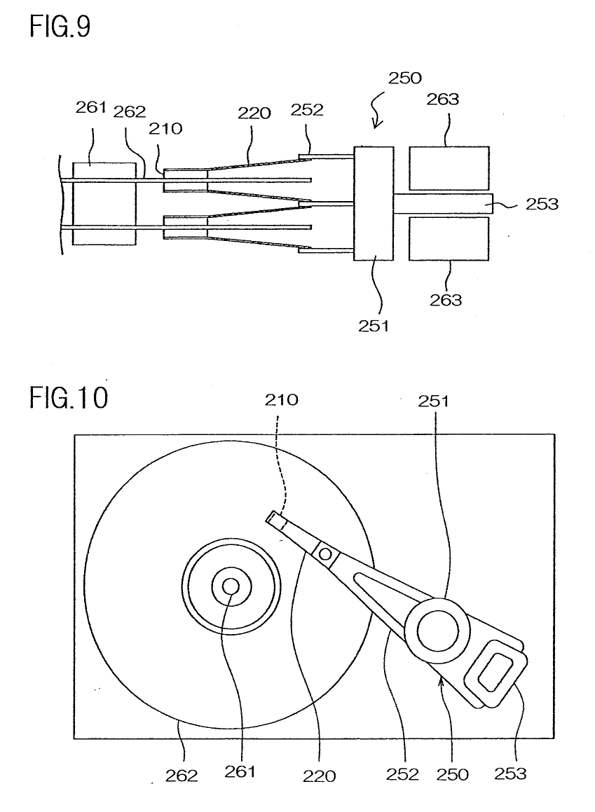

Referring to FIG. 9 and FIG. 10, a head stack assembly and a hard disk drive that incorporate the slider mentioned above will be explained next. The arrangement in which head gimbal assemblies 220 are attached to the respective arm of a carriage having a plurality of arms is called a head stack assembly. FIG. 9 is a side view of a head stack assembly, and FIG. 10 is a plan view of a hard disk drive. Head stack assembly 250 has carriage 251 provided with a plurality of arms 252. Head gimbal assemblies 220 are attached to arms 252 such that head gimbal assemblies 220 are arranged apart from each other in the vertical direction. Coil 253, which constitutes a part of the voice coil motor, is attached to carriage 251 on the side opposite to arms 252. The voice coil motor has permanent magnets 263 which are arranged in positions that are opposite to each other and interpose coil 253 therebetween.

Referring to FIG. 10, head stack assembly 250 is installed in a hard disk drive. The hard disk drive has a plurality of hard disks which are connected to spindle motor 261. Two sliders 210 are provided per each hard disk 262 at positions which are opposite to each other and interpose hard disk 262 therebetween. Head stack assembly 250 and the actuator, except for sliders 210, work as a positioning device in the present invention. They carry sliders 210 and work to position sliders 210 relative to hard disks 262. Sliders 210 are moved by the actuator in the transverse direction with regard to the tracks of hard disks 262, and positioned relative to hard disks 262. Magnetic field detecting element 1 that is included in slider 210 writes information to hard disk 262 by means of the write head portion, and reads information recorded in hard disk 262 by means of the read head portion.

Although certain preferred embodiments of the present invention have been shown and described in detail, it should be understood that various changes and modifications may be made without departing from the spirit or scope of the appended claims.

What is claimed is:

1. A magnetic field detecting element comprising:
a stack which includes a NiCr layer, a first magnetic layer whose magnetization direction varies in accordance with an external magnetic field, a non-magnetic spacer layer, and a second magnetic layer whose magnetization direction varies in accordance with the external magnetic field, said NiCr layer, said first magnetic layer, said spacer layer and said second magnetic layer being disposed in this order and being arranged in contact with each other, wherein a sense current is adapted to flow in a direction that is perpendicular to a film surface of said stack; and
a bias magnetic layer which is disposed on a side of said stack, said side being opposite to an air bearing surface of said stack, wherein said bias magnetic layer is adapted to apply a bias magnetic field to said stack in a direction that is perpendicular to said air bearing surface, wherein:
both first and second magnetic layers have bcc crystalline structures; and
said non-magnetic spacer layer has a film configuration in which an insulating layer or a semiconductor layer is inserted into a metal layer.

2. The magnetic field detecting element according to claim 1, wherein both first and second magnetic layers include a CoFe layer.

3. The magnetic field detecting element according to claim 1, wherein said non-magnetic spacer layer has a film configuration in which a ZnO layer is inserted into a Cu layer, and wherein said NiCr layer has an atomic percent of Cr that is 30% or more and 80% or less.

4. The magnetic field detecting element according to claim 1, wherein said non-magnetic spacer layer has a film configuration in which an AZO layer is inserted into a Cu layer, and wherein said NiCr layer has an atomic percent of Cr that is 35% or more and 80% or less.

5. The magnetic field detecting element according to claim 1, wherein said non-magnetic spacer layer has a film configuration in which a GaN layer is inserted into a Cu layer, and wherein said NiCr layer has an atomic percent of Cr that is 40% or more and 90% or less.

6. A slider that is provided with the magnetic field detecting element according to claim 1.

7. A wafer which has a stack formed thereon, wherein said stack is to be formed into the magnetic field detecting element according to claim 1.

8. A head gimbals assembly which has the slider according to claim 6 and a suspension for elastically supporting said slider.

9. A hard disc drive which includes the slider according to claim 6, and a device for supporting said slider and for positioning said slider with respect to a recording medium.
